(19) United States
(12) Patent Application Publication
(10) Pub. No.: US 2017/0095115 A1
(43) Pub. Date: Apr. 6, 2017

(54) CHARCOAL MANAGEMENT DEVICE

(71) Applicant: W.C. BRADLEY CO., Columbus, GA (US)

(72) Inventors: WILLIAM LADON HOPKINS, Columbus, GA (US); MALLIK AHMED, Columbus, GA (US); JOHN R. ALLEN, Cataula, GA (US); THOMAS H. WARD, CATAULA, GA (US); JESSICA JOHNSEY HINSHAW, AUBURN, AL (US)

(21) Appl. No.: 15/287,213

(22) Filed: Oct. 6, 2016

Related U.S. Application Data
(60) Provisional application No. 62/237,721, filed on Oct. 6, 2015.

(51) Int. Cl. A47J 37/07; F24B 1/191

(52) U.S. Cl. CPC A47J 37/0786; F24B 1/191

(57) ABSTRACT

A charcoal management device having a plate, an inner wall circumscribing an inner portion of the plate, and an outer wall circumscribing at least a portion of the plate outside the inner wall.

### CROSS-REFERENCE TO RELATED CASES

This application claims the benefit of U.S. provisional patent application Ser. No. 62/237,721 filed on Oct. 6, 2015, and incorporates such provisional application by reference into this disclosure as if fully set out at this point.

### FIELD OF THE INVENTION

This disclosure relates to use of solid cooking fuels in general and, more specifically, to a system for controlling the use and burn rate of solid cooking fuels.

### BACKGROUND OF THE INVENTION

Charcoal barbecue grills are often made in what may be called a kettle configuration with a generally spherical or ovoid shape divided into a bottom and a top. The bottom normally has an opening for combustion air somewhere at the lowest part. A grate for holding charcoal may be positioned in the bottom half below a grate for cooking food somewhere near the midline of the device. The top normally has an adjustable vent for controlling the flow of flue gases out of the grill. For the typical examples of this type of grill the charcoal grate and cooking grate will both be of generally circular configuration.

In grilling, where food is being cooked at relatively high temperatures for a relatively short period of time, the charcoal may be lit and spread over the charcoal grate. Due to the bottom air inlet, combustion and heat normally tends to be most intense in the center, creating suitable conditions for grilling over the middle of the cooking grate. This is described in technical detail in Modernist Cuisine, Vol. 2, Techniques and Equipment, Myhrvold, Young and Bilet, pages 14-17. To cook with less intense heat for a longer period of time with this type of grill the most common procedure is to put all the charcoal to one side of the charcoal grate and put the food to the other side of the cooking grate relying on convective circulation to cook the food.

One significant shortcoming of the methods described above is that when cooking (at either high intensity for a short period of time or low intensity for a long period of time) the heat may not be even across the cooking grate, or may not otherwise fully utilize the available surface area of the cooking grate.

In recent years newer kettle grill designs have been developed. Two of these are described in Danish patent DK 176696B1 to Martinsen and US Patent Application Publication No. 2014/0165993 A1 by Ahmed. In these products the combustion air is introduced circumferentially around the charcoal grate creating a more even heating of the charcoal and thus a more even heating of the food being cooked. Nevertheless, the prior practice of putting all the charcoal to one side of the charcoal grate and putting the food to the other side of the cooking grate and relying on convective circulation to cook the food is still needed at times to provide the desired heat intensity at the cooking grate.

What is needed is a system and method for addressing the above, and related, issues.

### SUMMARY OF THE INVENTION

The invention of the present disclosure, in one aspect thereof, a charcoal management device having a plate, an inner wall circumscribing an inner portion of the plate, and an outer wall circumscribing at least a portion of the plate outside the inner wall.

In some embodiments, the inner and outer wall define an annulus therebetween on the plate. A baffle may be provided traversing the annulus and interposing the inner wall and the outer wall. The baffle may be a double walled baffle. The inner wall may be double walled for at least a portion thereof. The inner wall may also be notched and/or define an open segment. The plate may define a plurality of openings inside the inner wall.

The invention of the present disclosure, in another aspect thereof, comprises a charcoal management device including a plate having a periphery with an outer wall rising therefrom, and an inner wall rising from the plate inside the inner wall to define an area on the plate inside the wall and an area on the plate in between the inner and outer walls. A portion of the inner wall has an opening that promotes passage of combustion of solid fuel from the area on the plate inside the inner wall to the area on the plate between the inner and outer walls.

The charcoal management device may further comprise a baffle extending from the inner wall to the outer wall. The baffle may extend from the inner wall proximate the opening on the inner wall. In some embodiments at least one additional baffle extends from the inner wall to the outer wall. The inner wall and the baffle may have a double-walled construction. In some embodiments, the area on the plate inside the inner wall is perforated.

The invention of the present disclosure, in another aspect thereof, comprises a charcoal management device with a plate for supporting solid cooking fuel on a grate inside a cooking grill, an outer wall enclosing at least a portion of an upper surface of the plate, and an inner, circular wall inside the outer wall. A portion of the inner wall has an opening that promotes passage of combustion of solid fuel from an area on the plate inside the inner wall to an area on the plate between the inner and outer walls, and the area on the plate inside the inner wall is perforated.

The charcoal management device may further comprise at least one baffle extending from the inner wall to the outer wall. This baffle may be a three dimensional baffle. Other embodiments include four baffles with one placed extending radially away from the inner wall approximately every 90 degrees. At least one of these four baffles may have a double walled construction. The inner wall may have a double walled construction as well.

### BRIEF DESCRIPTION OF THE DRAWINGS

To easily identify the discussion of any particular element or act, the most significant digit or digits in a reference number refer to the figure number in which that element is first introduced.

FIG. 1 is a perspective view of one embodiment of a charcoal management device according to aspects of the present disclosure.

FIG. 2 is a perspective view of another embodiment of a charcoal management device according to aspects of the present disclosure.

FIG. 3 is a perspective view of another embodiment of a charcoal management device according to aspects of the present disclosure.

FIG. 4 is a perspective view of another embodiment of a charcoal management device according to aspects of the present disclosure.

FIG. 5 is a plan view of the charcoal management device of FIG. 3 illustrating one possible arrangement of charcoal briquettes therein and an associated burn pattern.

FIG. 6 is a perspective view of another embodiment of a charcoal management device according to aspects of the present disclosure.

### DETAILED DESCRIPTION OF THE PREFERRED EMBODIMENTS

In existing kettle grills, and other types of grills, various embodiments of the present disclosure may operate to deliver full and even heating from solid fuels (e.g., charcoal) to the entire cooking grate. This is particularly so where lower heating levels are to be utilized over longer periods of time.

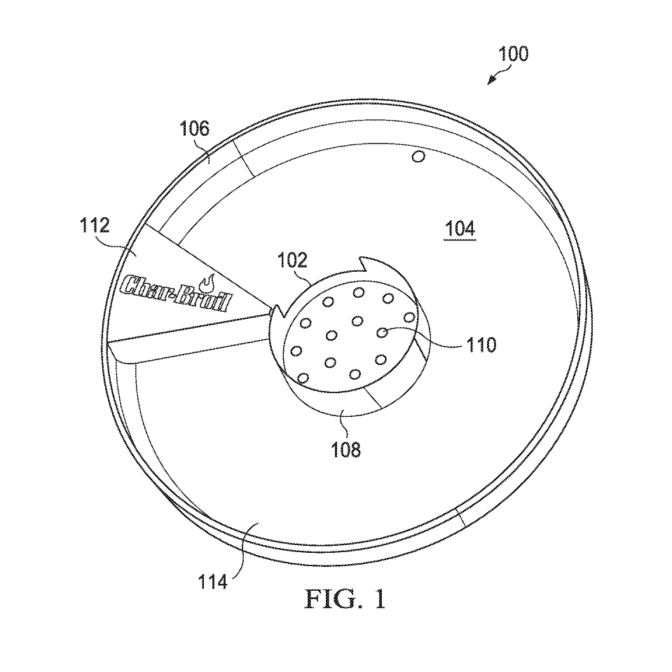

Referring now to FIG. 1, an exemplary embodiment of a charcoal management device 100 is shown. The charcoal management device 100 comprises a plate 104, which may be circular, as shown, or may have other shapes. The plate 104 may be generally flat or planar in order to rest in a stable position up the charcoal grate of the grill in which the device 100 is used. One benefit of a circular plate 104 (and overall round shape to the charcoal management device 100) is that a ready fit may be provided for the circular charcoal grate of existing kettle type grills.

The plate 104 may have a ring or outer wall 106 affixed to the plate 104 and circumscribing it near an outer edge thereof. The outer wall 106 may attach to the circumference of the flat plate and an inner ring or inner wall 108 may attach to a top surface of the plate 104. An annulus 114 may therefore be defined on the plate 104 between the outer wall 106 and inner wall 108. The outer wall 106 may be solid or provided with a set of openings (not shown) around its circumference for the admission of combustion air. The walls 106, 108 may rise perpendicularly from the plate 104 or may be angled. Walls 106, 108 may also comprise peaked structures having a wider base and a narrower upper peak.

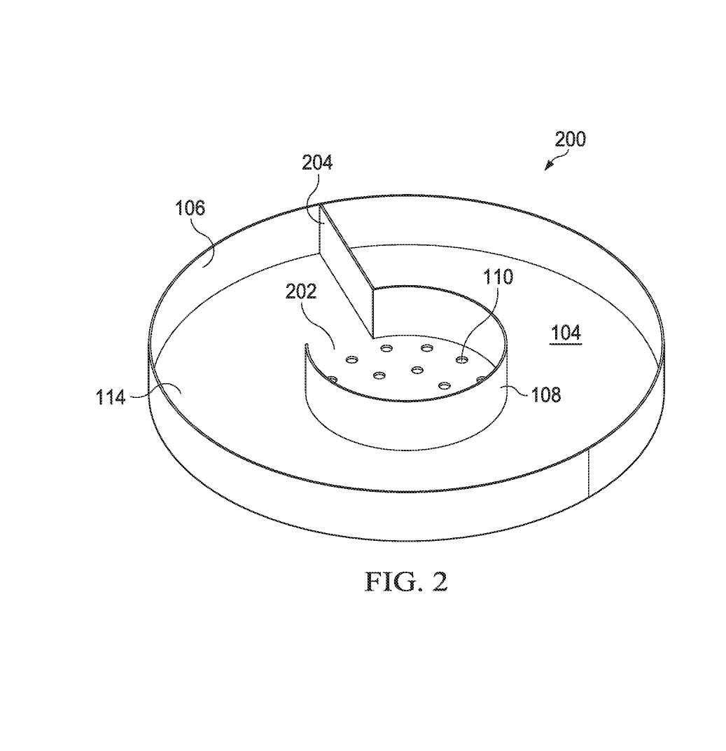

The inner wall 108 may be solid except for a notch 102 (or multiple notches) cut into a lower or upper portion of the inner wall 108. In other embodiments, a complete segment of the inner wall 108 is removed. For purposes of the present disclosure, a notch may be considered removal or absence of a portion of the inner wall 108 that leaves the modified or notched portion of the inner wall adjacent to the plate 104 in place (as in FIG. 1). Removal of a complete segment is considered to mean removal of an entire portion of the wall, all the way to the plate 104 to create an open segment (as in FIG. 2).

In the area of the plate 104 encompassed by the inner wall 108 there may be a number of openings 110 (e.g., holes or perforations) for the admission of combustion air. The diameter of the outer wall 106 (and/or plate 104) is in a range of values around one half the diameter of the cooking grate of the applicable grill, but not larger than the charcoal grate of the grill upon which it is placed in operation. The diameter of the inner wall 108 is in a range of values of 35% to 50% of the diameter of the outer ring and is placed generally concentric with the outer wall 106. The height of the inner wall 108 and/or the outer wall 106 may be 1″, 2″ or 3″. The inner wall 108 and the outer wall 106 are not required to have the same height for proper functioning in all embodiments.

Baffles can be placed that extend from the outer periphery of the inner wall 108 to the inner periphery of the outer wall 106 in a generally radial direction (see, e.g., triangular or wedge shaped baffle 112 of FIG. 1). These baffles are of a height generally equivalent to the height of the inner wall 108 and/or outer wall 106. It will be understood that these baffles are not essential to the functioning of every embodiment of the device but can be used to produce various burning patterns or directions and to control burn time. One skilled in the art will appreciate that variations of inner ring and baffle configurations can be constructed to produce variation in the burning pattern and rate. Only some baffle configurations are illustrated and described in detail herein.

Some baffles, such as baffle 112, occupy part of the volume of the charcoal management device, such as that below the outer wall 106 and bounded by the inner wall 108 and outer wall 106. Such a baffle may comprise multiple walls such that fuel may not be placed inside the baffle itself. The baffle 112, for example, provides at least two side walls extending vertically from the plate 104 that are then topped by a cover. This wedge shaped baffle 112 therefore defines a three dimensional volume within the charcoal management providing that reduces the amount of total fuel that can be placed in the charcoal management device 100. The baffle 112 still provides a guide and/or impediment to the direction combustion travels through the device 100 so long as it does not completely block the desired burn path. As shown in FIG. 1, for example, combustion will travel clockwise around the charcoal management device 100 after escaping the inner wall 108 until all charcoal or other fuel on the plate 104 has been consumed. The total burn time will be reduced, however, because of the volume occupied by the baffle 112.

In the grills for which the devices of the present disclosure are suited, such device may be placed on a charcoal grate and four to eight standard briquettes, or an equivalent amount of lump charcoal, is placed inside the inner wall 108. Forty to sixty standard briquettes, or an equivalent amount of lump charcoal, may be placed in the annular space between the inner wall 108 and outer wall 106. In addition, lumps of wood, dry or pre-soaked, can be mixed with the charcoal briquettes, particularly in the annular space between the inner wall 108 and outer wall 106. The briquettes in the inner wall 108 are then ignited. In a reasonably short period of time (on the order of 10 to 15 minutes) the charcoal in the inner wall 108 will be lit and the fire will begin to spread into the annular space though the notch 102 (or open segment 202, see FIG. 2) cut into the inner wall 108.

In some embodiments, baffles placed between the inner and outer rings provide further control of the spread of the fire between the inner and outer rings. With the fire starting in the center and the combustion air being brought in from the periphery or just above the periphery of the annular space between the inner and outer rings, the fire developed is very even and of an intensity easily controlled by the exhaust vents on the top or lid of the grill. Tests have shown that fires made in this manner on various embodiments of the present disclosure can last for 4 to 5 hours, fully sufficient for cooking large cuts of meat.

Referring now to FIG. 2, another embodiment of a charcoal management device 200 is shown. Here the inner wall 108 has an open segment 202 rather than a notch 102 (FIG. 1). A single radial baffle 204 spans between one end of the inner wall 108 (e.g., where the open segment 202 is removed) and the outer wall 106. It should be understood that a straight radial baffle 204 is illustrated but a curved or straight baffle that is not strictly radial in orientation could be appropriate in some embodiments. The baffle 204 is also a relatively thin single wall (as opposed to having a defined interior volume as with baffle 112). The baffle 204 may be placed near or adjacent the open segment 202 in order to ensure that, as the combustion moves from inside the wall 108 into the annulus 114 it proceeds to consume the charcoal in the annulus 114 in an orderly and controlled fashion. In the embodiment shown, the baffle 204 blocks the spread of combustion and thus the combustion and consumption of the charcoal spreads in a counter-clockwise fashion after escaping the inner wall 108.

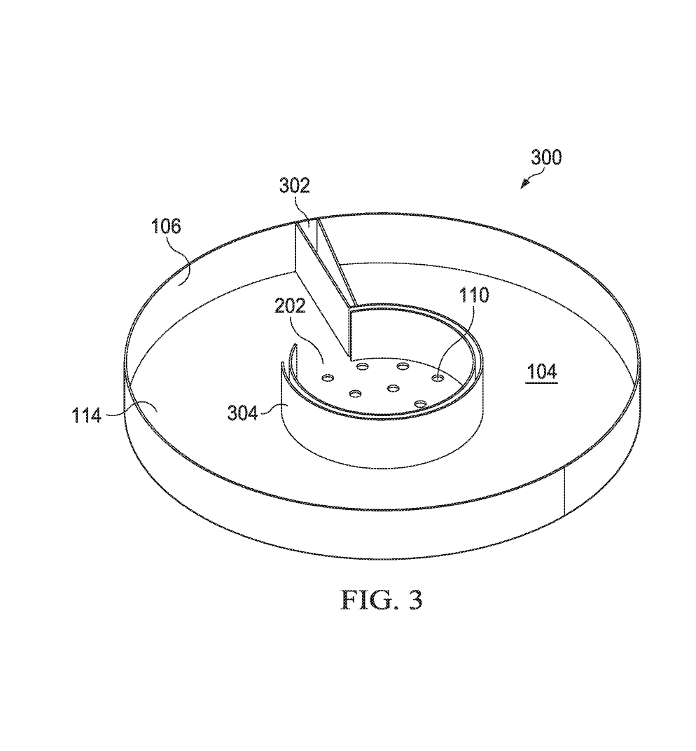

Referring now to FIG. 3, a perspective view of another embodiment of a charcoal management device 300 is shown. Here the inner ring and baffle take the form of double inner wall 304 and double radial baffle 302. These double walled structures serve to reduce the rate of heat transfer through the initially hotter double inner wall 304. The double walled structures may have relatively narrow separation between the spaced apart walls. This may, for example, be too small of a space to have concern over a charcoal briquette falling therein. In some embodiments the space inside the double wall is less than 1 inch. In other embodiments it is less than 0.5 inches or less then 0.25 inches. Nevertheless, even a small space will reduce heat transfer through the double walled structure.

The use of certain double walled structures (e.g., the baffle 302 and inner wall 304) produces relatively more active burning in a spiral path from the open segment 202 of the double inner wall 304 around the annulus 114 between the double inner wall 304 and outer wall 106, and relatively less active burning by heat transfer from the inner ring to the inner pieces of charcoal in the annulus 114. Depending on the properties of the grill in which the devices of the present disclosure are used, the size, quantity, and quality of the charcoal, and the desired cooking characteristics, double walls (for baffles or inner wall segments) may or may not be needed. In some embodiments, the inner wall 304 may be a double wall while one or more baffles (e.g., 302) are not. The converse (e.g., double walled baffles and singled walled inner wall) may also be true.

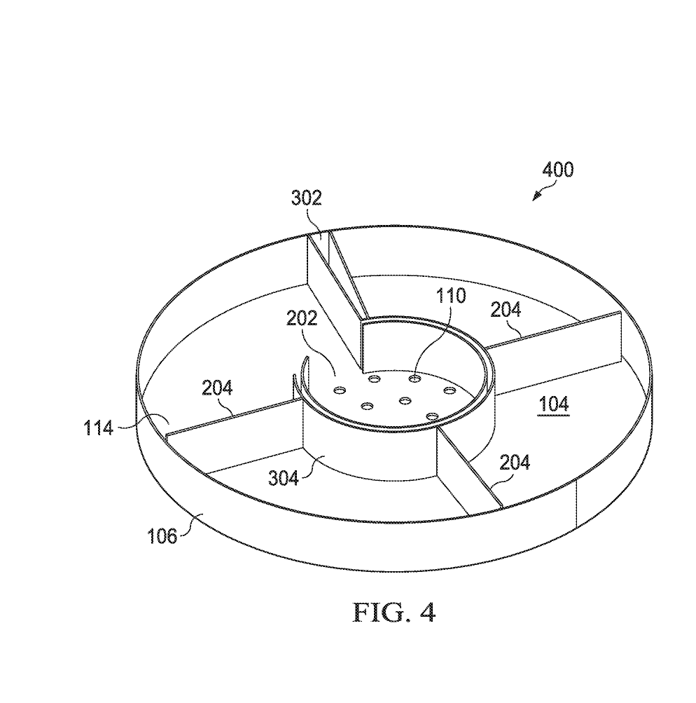

Referring now to FIG. 4 a perspective view of another embodiment of a charcoal management device according to aspects of the present disclosure is shown. FIG. 4 illustrates a variation of the embodiment shown in FIG. 3 with three additional radial baffles 204. Considering the double radial baffle 302 as well, a baffle appears on the annulus 114 about every 90 degrees. The radial baffles 204 delay, the progression of burning around the annulus 114 between the double inner wall 304 and the outer wall 106, thus producing a longer burn time with the same amount of fuel. To further control burn time, the double radial baffle 302 and/or the radial baffles 204 may have notches, cutouts, or other openings (not shown). Even where the radial baffles 204 do not provide notches cutouts or other openings, they may only serve to delay the spread of combustion, rather than substantially eliminate it (as, in the present embodiment, with the double inner wall 304 and the radial baffle 302).

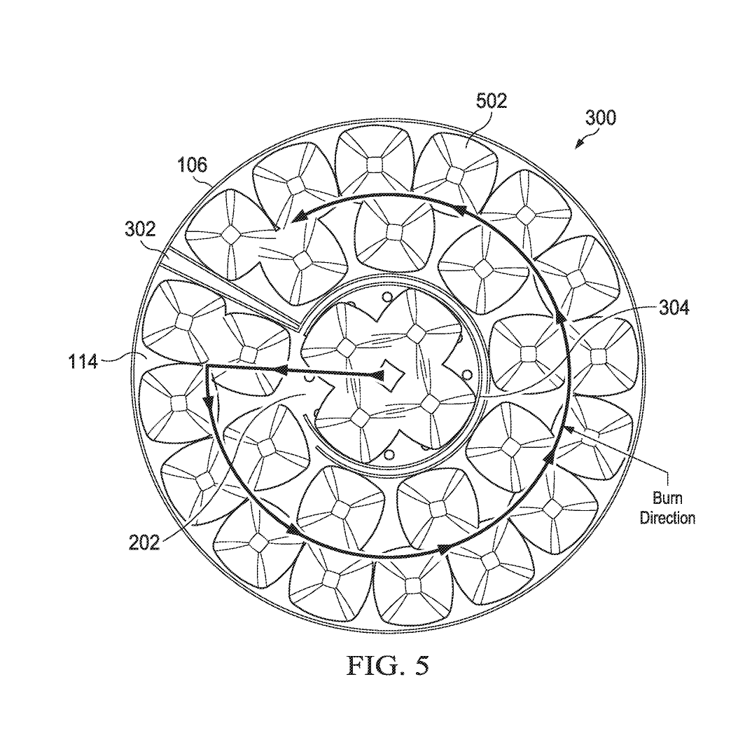

Referring now to FIG. 5, a plan view of the charcoal management device of FIG. 3 illustrating one possible arrangement of charcoal briquettes therein and an associated burn pattern is shown. The charcoal briquettes 502 may be placed on the annulus 114 and inside the double inner wall 304 so as to substantially fill these areas. An appropriate amount of lump charcoal could also be used. The charcoal briquettes 502 may be ignited or lit inside the double inner wall 304. Initially, this is where the heat from the ignited charcoal briquettes 502 will be produced. The double inner wall 304 may prevent spread of combustion except via the open segment 202 where the combustion will proceed, over time, to the annulus 114. The double radial baffle 302 may prevent or delay combustion from moving clockwise (or counterclockwise if the location of the double radial baffle 302 is moved to the opposite side of the open segment 202). Combustion may proceed unimpeded counter clockwise around the annulus 114 as shown by the arrow. The controlled delay of the movement of combustion provides for increased burn time at lower temperatures relative to an ordinary charcoal pan or grate.

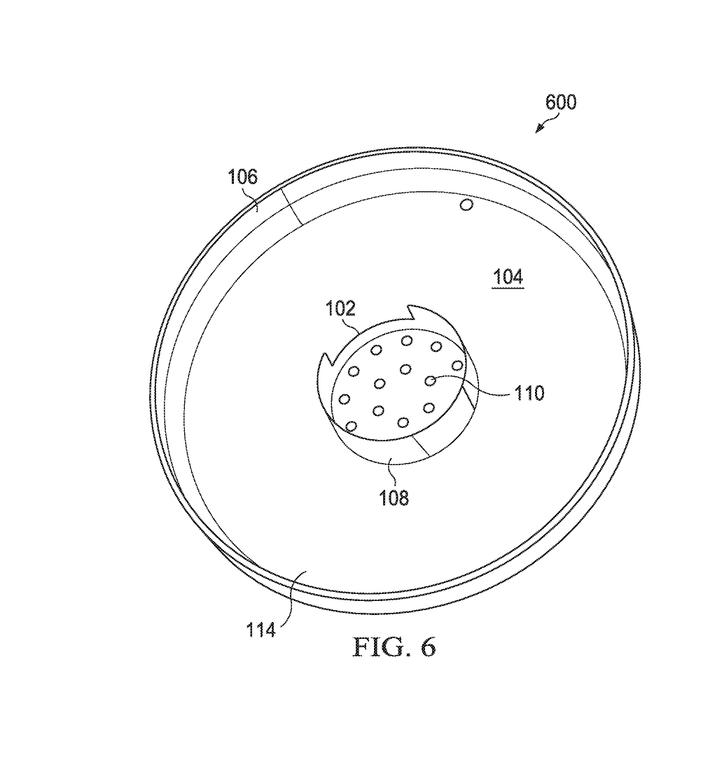

Referring now to FIG. 6, a perspective view of another embodiment of a charcoal management device according to aspects of the present disclosure is shown. The charcoal management device 600 provides an outer wall 106 and inner wall 108 enclosing an annulus 114 on the plate 104. The charcoal management device 600 is similar to the charcoal management device 100 of FIG. 1 but for the lack of baffles on the annulus 114. Combustion, once escaping the inner wall 108 via the notch 102 is free to travel in both directions about the annulus 114. This may result in a faster burn time and greater heat than embodiments providing baffles. However, the burn rate is still controlled (lengthened and at a reduced temperature) compared to an ordinary pan or grate. It will be appreciated that utilizing various configurations of baffles, notches, cutouts, and openings, the burn rate and heat can be tailored as needed.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the invention as defined by the claims.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A charcoal management device comprising:
a plate;
an inner wall circumscribing an inner portion of the plate; and
an outer wall circumscribing at least a portion of the plate outside the inner wall.

2. The charcoal management device of claim 1, wherein the inner and outer wall define an annulus therebetween on the plate.

3. The charcoal management device of claim 2, further comprising a baffle traversing the annulus and interposing the inner wall and the outer wall.

4. The charcoal management device of claim 3, wherein the baffle is a double walled baffle.

5. The charcoal management device of claim 1, wherein the inner wall is double walled for at least a portion thereof.

6. The charcoal management device of claim 1, wherein the inner wall is notched.

7. The charcoal management device of claim 1, wherein the inner wall defines an open segment.

8. The charcoal management device of claim 1, wherein the plate defines a plurality of openings inside the inner wall.

9. A charcoal management device comprising,
a plate having a periphery with an outer wall rising therefrom; and
an inner wall rising from the plate inside the inner wall to define an area on the plate inside the wall and an area on the plate in between the inner and outer walls;
wherein a portion of the inner wall has an opening that promotes passage of combustion of solid fuel from the area on the plate inside the inner wall to the area on the plate between the inner and outer walls.

10. The charcoal management device of claim 9, further comprising a baffle extending from the inner wall to the outer wall.

11. The charcoal management device of claim 10, wherein the baffle extends from the inner wall proximate the opening on the inner wall.

12. The charcoal management device of claim 11, wherein at least one additional baffle extends from the inner wall to the outer wall.

13. The charcoal management device of claim 11, wherein the inner wall and the baffle have a double-walled construction.

14. The charcoal management device of claim 9, wherein the area on the plate inside the inner wall is perforated.

15. A charcoal management device comprising:
a plate for supporting solid cooking fuel on a grate inside a cooking grill;
an outer wall enclosing at least a portion of an upper surface of the plate; and
an inner, circular wall inside the outer wall;
wherein a portion of the inner wall has an opening that promotes passage of combustion of solid fuel from an area on the plate inside the inner wall to an area on the plate between the inner and outer walls; and
wherein the area on the plate inside the inner wall is perforated.

16. The charcoal management device of claim 15, further comprising at least one baffle extending from the inner wall to the outer wall.

17. The charcoal management device of claim 16, wherein the at least one baffle is a three dimensional baffle.

18. The charcoal management device of claim 16, further comprising four baffles with one placed extending radially away from the inner wall approximately every 90 degrees.

19. The charcoal management device of claim 16, wherein at least one of the four baffles has a double walled construction.

20. The charcoal management device of claim 19, wherein the inner wall has a double walled construction.
